(19) United States
(12) Patent Application Publication
(10) Pub. No.: US 2009/0161879 A1
(43) Pub. Date: Jun. 25, 2009

(54) Sound Signal Processing Device, Method of Processing Sound Signal, Sound Reproducing System, Method of Designing Sound Signal Processing Device

(76) Inventor: Hirofumi Yanagawa, Narashino-shi (JP)

Correspondence Address: JACOBSON HOLMAN PLLC, 400 SEVENTH STREET N.W., SUITE 600, WASHINGTON, DC, 20004, US

(21) Appl. No.: 12/085,991

(22) PCT Filed: Dec. 5, 2005
(86) PCT No.: PCT/JP2005/022282

§ 371 Date: Sep. 4, 2008

(51) Int. Cl. H04R 5/00

(52) U.S. Cl. 381/17

(57) ABSTRACT

[Problems to be Solved] At regeneration of sounds by a speaker having common vibration boards for left and right channels allows an audience to percept a broader sound field.

[Means for Solving the Problems] An acoustic regeneration system for regenerating sounds by a speaker 20 provided with a transparent panel 24 of a liquid crystal apparatus and oscillators 26 fro vibrating the transparent panel 24 in response to signals of left and right channels is provided with a pair of input terminals 32 receptive of signals of the left and right channels, a prescribed band-pass characteristics for a plurality of prescribed bands, a pair of sound field adjustment filters 38, an operational output 32 for subtracting signals of other channels past the sound field adjustment filters 38 from the input left and right channel signals to output the result as the channel signal of a corresponding signal of the speaker 20 and a delay circuit arranged before the operational output 36.

### TECHNICAL FIELD

The present invention relates to apparatus and method for regeneration of acoustic signals via a speaker provided with common vibration boards in left and right channels.

### TECHNICAL BACKGROUND

A system for enlargement of sound field has been known in which audio image orientational direction, i.e. a direction in which an audience feels presence of a sound source, can be enlarged more than the distance between the left and right speakers for processing acoustic signals supplied to the speakers in a sound regeneration system.

For example, in the system disclosed by a non-patent publication 1, transmission function from a sound source to the ears of an audience (HRTF) is folded in acoustic signals from left and right channels and the audience is made to perceive a sound field in which sounds come from that sound source position.

A system is also disclosed by a non-patent publication 2 in which cross talk between left and right channels is cancelled in regeneration by a speaker through combination of such cross talk cancellation with the system disclosed by the non-patent publication 1 and more effective enlargement of audio image orientational direction can be achieved whilst canceling the cross talk between channels and enlarging the sound field.

Incidentally, a non-patent publication 3 discloses a speaker system in which oscillators are arranged on both sides of a transparent panel covering the surface of a liquid crystal display and the liquid crystal panel is vibrated by the oscillator to generate sounds. Such a speaker system well reduces an installation space through integration of a liquid crystal display with a speaker and enhances feel of presence through generation of sounds and images from a same position. The non-patent publication 1: D. B. Andreson et al, “The sound dimension”, IEEE SPECTRUC, March 1997.

A non-patent publication 2: M. R. Shcroeder et al, “Comparative study of European concert halls: correction of subjective preference with geometric and acoustic parameters”, J. Accoust, Soc. Am. Vol. 55, No 4, October 1974.

A non-patent publication 3: “The NXT Technology Review 01”, (on line) (search 18^{th} May, Heisei-16). Internet <URL:http://www.flatspeaker.com/nxtsound/technology/techReview.php).

### DISCLOSURE OF THE INVENTION

### Technical Problems to be Solved by the Invention

FIG. 13 depicts one example of the frequency characteristics of a speaker provided with common vibration boards in left and right channels as disclose by the non-patent publication 3. The depicted frequency characteristics was obtained by measuring sound pressure in front of the speaker whilst supplying acoustic signals to one channel only. As shown with black circles in the illustration, a number of big level-down points appearing in this speaker frequency characteristics. This is believed to be caused by generation of negation of emitted sounds duet to partial reverse phase vibration of the vibration boards.

In the system disclosed by the non-patent publication 2, an acoustic signal left and right channel is multiplied by 1/S and 1/(1−C2). Here, C=A/S, S represents respective transmission functions from left and right speakers to on ear of an audience and A represents respective transmission functions from the left and right speakers to the other ear of the audience.

As a consequence, when this system is applied to the speakers disclosed by the non-patent publication 3, the value of S becomes close to zero at the frequency of the big level-down point such as shown in FIG. 13, division by this value is carried out to cause poor convergence of the response and no desired acoustic characteristics can be obtained in a practical range.

The present invention was proposed in consideration of the above-described state of art. It is the object of the present invention is to allow an audience to perceive a broad sound field at regeneration of sounds by speakers provided with common vibration boards in left and right channels.

### Means for Solving the Technical Problems

In accordance with the acoustic signal processing apparatus of the present invention, common vibration boards are arranged in left and right channels and oscillators corresponding to the channels are arranged to vibrate the vibration boards in accordance with signals form the channels for sound regeneration. A pair of input terminals are provided for reception of the signals from the channels and a pair of sound field adjustment filters are provided with preset band-pass characteristics in a plurality of frequency bands. The adjustment filters allow passage of the signals from the above-described channels. Signals from other channels past the above-described filters are subtracted from the signals from the above-described channels and the results are output by an operational output as channel signals corresponding to the above-described speakers.

In one embodiment of the present invention, the above-described sound field adjustment filter takes the form of a digital filter of a passage characteristics which is a sum of band-pass filters over a plurality of frequency bands, the band-pass filter having a predetermined band-pass characteristics over respective predetermined frequency bands. When a liner phase FIR filter is used for this band-pass filter, frequency bands become equal to each other in phase delay time and there is no need for dislocating time axis at addition of respective band characteristics for simpler filter design.

In another embodiment of the present invention, a delay circuit, which has a delay time corresponding to the phase delay time of the above-described sound field adjustment filter. By employing such delay circuit, it is possible to match the phases of respective channel signals to the phases of signals supplied from other channel through the sound field adjustment filter, thereby performing effective acoustic signal processing for sound field enlargement.

In the other embodiment of the present invention, the above-described sound adjustment filter is made up of a plurality of band-pass filters arranged in correspondence to a plurality of predetermined frequency bands respectively above-described the above-described operational output may perform subtraction of acoustic signals of other channels past the above-described plurality of band-pass filters from input signals to left and right channels.

Further, the present invention relates to acoustic signal processing method for sound regeneration by a speaker which is provided with common vibration boards arranged in left and right channels and oscillators corresponding to the channels in order to vibrate the above-described vibration boards corresponding to left and right channel signals. In the method, input signals to the left and right channels are passed through filters having band-pass characteristics predetermined for a plurality of prescribed frequency bands respectively, signals form other channels past the above-described filter are subtracted from the input signals to the left and right channels and this result is output as channel signals corresponding to the above-described speakers.

The acoustic system in accordance with the present invention is provided with a speaker including common vibration boards arranged in left and right channels and oscillators corresponding to the left and right channels to vibrated the above-described vibration boards in accordance with left and right channel signals, a pair of input terminals receptive of the left and right channel signals, a pair of sound field filters having band-pass characteristics preset for a plurality of predetermined frequency bands and allowing passage of the above-described input left and right channel signals and an operational output which subtracts other channels signals past the above-described filters from the above-described input left and right channel signals for output as channel signals corresponding to the above-described speaker.

The method for designing acoustic signal processing apparatus of the present invention includes a step in which impulse responses of band-pass filters BPᵢ corresponding to a plurality of frequency bands I (i=1 to N: N is the number of the bands) respectively to form the first test signal Smᵢ, a step in which the phase of the above-described first test signal Smᵢ is inverted to form the second test signal Scᵢ, a step in which the above-described first test signal Smᵢ is input to the one channel of the above-described speaker, the above-described second signal Scᵢ is input to the to other channel of the above-described speaker past a time delay regulator and a level regulator, a step in which sounds generated by the above-described speaker are collected by a microphone to acquire their measurement signals SLᵢ, a step in which a microphone collects sounds generated when a sound source generative of a sound corresponding to the first or second test signals Smᵢ, Scᵢ is arranged on left or right side of the speaker to acquire reference signals Sl* and Sr*, a step in which time delay and level are regulated by the time delay and level regulators for approximation of the measurement signals SLᵢ and Srᵢ to the above-described reference signals SL*, SR*, a step in which an adjustment time delay τᵢ is determined by the above-described adjusted time delay, a step in which an adjustment gain kᵢ is determined by a gain of the above-described level with respect to the above-described first test signal Smᵢ, a step in which the impulse response δᵢ is multiplied by the adjustment gain kᵢ and only the adjustment time delay τᵢ is delayed to result an impulse response heᵢ and a step in which this impulse response heᵢ is summed over the entire frequency bands to fix the response he of the above-described filters.

The method for designing acoustic signal processing apparatus of the present invention includes a step in which impulse response of band-pass filters BPᵢ corresponding to a plurality of frequency I (i−1 to N, N is the number of bands) are measured to obtain the first test signal Smᵢ, a step in which the above-described first test signal Smᵢ is input to one channel of the above-described speaker, the above-described second test signal Scᵢ is input to the other channel of the speaker past a time delay regulator and a level regulator and sounds generated by the speaker are collected by an microphone to obtain its measurement signals SLᵢ and SRᵢ, a step in which reference signals SL*ᵢ,SR*ᵢ are obtained by folding of the above-described first test signal Sm and a both ear impulse response over frequency bands corresponding to the frequency band I in the form of a Fourier reverse transformation of the transmission function HRTF from a left or right position of the speaker to the head of an audience, a step in which the time delay and the level are adjusted by the time delay and level regulators for approximation of the measurement signals SL*ᵢ, SR*ᵢ to the reference signals, a step in which an adjustment gain kᵢ is formed by a gain of the adjusted level to the first test signal Smᵢ, a step in which the above-described impulse response δᵢ is multiplied by the adjustment gain kᵢ and is delayed by the above-described adjustment time delay τᵢ to form an impulse response heᵢ and a step in which this impulse response is summed over the entire frequency bands to form a response he of the speaker.

### MERITS OF THE INVENTION

In accordance with the present invention, an audience is allowed to perceive a broad sound field at regeneration of sounds by a speaker having common variation boards in left and right channels.

### THE BEST MODE OF EMBODYING THE INVENTION

FIG. 1 depicts the system diagram of an acoustic regeneration system 10 which is one embodiment of the present invention. As illustrated in FIG. 1, the acoustic regeneration system of this embodiment includes a speaker 20 and a acoustic signal processing apparatus 30, the speaker 20 being explained first.

FIG. 290 is a cross-sectional view of the speaker 20. The speaker 20 of this embodiment is integrated with, for example a crystal display for personal computers and is provided with, for example, acrylic transparent panel 24 covering the surface of a crystal unit 22 and oscillators 26L, 26R of left and right channels arranged between a supporter 25 for the crystal unit 22 and the transparent panel 24. The oscillator 26 is made up of, for example, a voice coil or a piezo-electric element and the oscillator 26L, 26R of the respective channels vibrate the transparent panel 24 on receipt of acoustic signals for acoustic generation. Thus, the speaker 20 of this embodiment is structured to have common vibration boards (i.e. the transparent panel 24) in the left and right channels. Incidentally, a plurality of oscillators 26L. 26R may be employed for each channel.

As explained in reference to FIG. 13, many level drops appear in the frequency characteristics of the construction like the speaker 20 having common vibration boards in the left and right channels and no sufficient effect can be acquired by use of the conventional acoustic processing system for enlargement of audio image orientational direction of sounds generated by the speaker 20. In contrast to this, signal processing by the acoustic signal processing apparatus 30 enables enlargement in audio image orientational direction of the sounds regenerated by the sound 20 and perception by audience of broadened sound field.

Next, explanation proceeds to the acoustic signal processing apparatus 30.

As shown in FIG. 1, the acoustic signal processing apparatus 30 is provided with input terminals 32 (32L, 32R) receptive of acoustic signals from the left and right channels, orientational outputs 36 (36L, 36R) and sound field adjustment filters 38 (38L, 38R), The input terminals 32 are receptive of digitalized acoustic signals. Alternatively, however, an AD transducer may be built in the acoustic signal channel apparatus 30 for conversion of input analogue signals into digital signals. Input signals of the respective channels are supplied to the operational outputs 30 through the delay circuit 34.

The input signal of the left channel is supplied to the right channel operational output 36R past the sound field adjustment filter 38L and the operational output 36R outputs a signal obtained by subtracting (or adding after phase inversion) left channel signal past the sound field adjustment filter 38 left and right the right channel signal past the delay circuit 34. Similarly, right channel input signal is supplied to the left channel operational output 36L and the operational output 36L performs subtraction (or addition after phase inversion) between the left channel signal past the delay circuit 34L and the right channel signal past the sound field adjustment filter 38R for signal output. Output signals from the operational output 36L are supplied to the oscillators 26L, 26R of the speaker 20 after DA conversion.

As stated later in detail, the sound field adjustment filter 38 has characteristics in the form of the sum of band-pass filters with impulse response as band-pass characteristics set for a plurality of frequency bands. The delay circuit 34 delays phases of the channel input signals in accordance with time delay by the sound field filter 38. This enables phase matching of the signals added or subtracted by the operational outputs 36.

In general in acoustic regeneration system, enlargement of sound field is reduced due to presence of sounds output form left and right speakers and input to opposite ears of an audience. Transmission functions of sounds from the left and right speakers differs from each other in different frequency bands. In contrast, this embodiment passes acoustic signals from the left and right channels though sound field adjustment filters 38 with impulse response set for each frequency band and performs subtraction (or addition after phase inversion) vs acoustic signals from other channels, thereby producing a broad sound field.

Next, designing of the sound field adjustment filter is explained.

FIG. 3 depicts a flow chart of the designing and FIGS. 4 to 11 depict respective steps of FIG. 3.

In step 100 of FIG. 3, an impulse response of, say, ¼ octavo (the number of pulse filters) are calculated to form the first test signals. The central left and right frequency fc₁ of each band-pass filter BPᵢ, the band width fνᵢ and the number N are selected to cover the frequency range of processing of acoustic signals (for example 1000 to 3000 Hzs). In the case of this embodiment, a linear phase FIR band-pass filter is used for the band-pass filter BPᵢ, for example.

In step 102, the first signal Smᵢ is phase inverted as shown in FIG. 5 to form the second test signal Scᵢ.

In step 104, the first signal Smᵢ is input to the oscillator 26L of the left channel of the speaker 20 as shown in FIG. 6, the second test signal Scᵢ is input to the right channel oscillator 26R past the time delay regulator 50 and level regulator 25 and sounds generated by speaker 20 are collected by a dummy head microphone 54 arranged forwards to form measurement signals SLᵢ, Srᵢ. The dummy head microphone 54 is able to collect sound pressures at both ear positions of an audience.

In step 106, the time delay and level of the second test signal Sc are adjusted so that the time and level difference of the measurement signals SLᵢ, Srᵢ of the dummy microphone 54 should most approximate to the time and level difference of the left and right signals (hereinafter referred to as “reference signals”) measured when a single speaker is arranged at a position left side of the left side oscillator 24L. The adjusted time delay is regarded as an adjusted time delay τᵢ and the proportion (Mcᵢ/Mnᵢ) between the maximum value Mcᵢ of the adjusted second test signal Scᵢ and the maximum value Mmᵢ of the adjusted first signal Smᵢ is regarded as a regulation gain kᵢ.

Incidentally as shown in FIG. 7, the reference signals SL* and SR* have been measured in advance by arranging a usual type reference speaker 56 with left and right channel independence and imputing the first test signal Smᵢ to this reference speaker 56. The reference signals SL* and SR* may be measured by inputting the second test signal Scᵢ to the reference speaker 56.

A signal similar to the positioning of the sound source can be acquired through folding of the first test signal Smᵢ with the both ear impulse response which take the form of the Fourier reverse transformation of the transmission function HRTF from a position left side of the audience to the head of the audience S re the corresponding frequency range. These signals may be regarded as the reference signals Sl* and SR*.

The sound source is positioned left side in the foregoing case, left-or-right positioning may be selected in accordance with the sound image orientational direction to be broadened.

In step 108 next, when time delay and gain coincide or are within a prescribed tolerant limit (for example, ±10%) in adjacent two or more frequency bonds regarding the adjustment time delay τᵢ and adjustment gain kᵢ of each frequency band I, obtained in the above-described steps 104 and 106, These are integrated into a single band and common adjustment time delay and adjustment gain values are used. For example, when adjustment time delays τₛ, τₛ₊₁ and adjustment gains kₛ, kₛ₊₁ coincide respectively in bands s and (s+1), the bands are integrated as shown in FIG. 8 to obtain a band-pass filter of characteristics able to cover the passage bands of the band-pass filters of the bands s and (s+1) before integration. When bands are integrated like this, a band after integration is regarded as a single band with new allocation of the band number i.

Next in step 110, an impulse response δᵢ is calculated for each band-pass filter of each band I in order to obtain its phase delay time T (i.e. the time necessary for arrival of the impulse response at the peak value). For example, when an impulse response is obtained as shown in FIG. 9, the phase delay time T is equal to T₀. Incidentally, when a linear phase FIR band-pass filter is used for the band-pass filter BPᵢ and the tap number of the filter is equal to M, the phase delay time T corresponds to N/2 taps and the phase delay time T assumes a same value for each band. While, when a band-pass filter other than the linear phase FIR type, the phase delay time T assumes different values for different phases. In that case, impulse responses of other bands are delayed following the band of the signal phase delay time so that the phase delay time should assume a same value for each band.

In the next step 112, the phase delay time T obtained above is used for the delay time of the delay circuit 34.

Next in step 114, the impulse response δi of each band is delayed only by the adjustment time delay τ τ of the corresponding band I as shown in FIG. 10 and multiplied by the adjustment gain kᵢ to produce an impulse response hcᵢ.

Next in step 116, one impulse response hc is obtained by addition of all the impulse responses hc and the impulse response hc is used as the passage characteristics of the sound field adjustment filter 38 as shown in FIG. 11.

In the designing process shown in FIG. 3, since the characteristics of the sound field adjustment filter 38 is fixed on the basis of the speaker 20, an optimum sound field filter 38 corresponding to the sonic characteristics of the speaker 20 can be deigned. In that case, since the filter characteristics are designed using the impulse responses of respective frequency bands, more appropriate filter designing can be carried out in consideration of change in sonic transmission characteristics corresponding to frequency difference. Additionally, since an audio image orientational direction corresponding to the position of the reference speaker 25 for measurement of the reference signals SL* and SR* at fixing of the characteristics of the sound field adjustment filter 38, adjustment in audio image orientailnal direction is possible by appropriated fixing of the position of the reference speaker 56.

In the present embodiment, acoustic signals of the left and right pps are passed through the sound field adjustment filter 38 and subtracted from acoustic signals of other pps. No division by acoustic signals of other channels is performed unlike the system of the above-described non-patent publication 2. As a consequence, effective enlargement of the sound image orientational direction is possible through use of the speaker 20 with a lot of frequency characteristics drops.

FIG. 12 depicts with a wave A the level difference (FIG. 12a) and the phase difference (FIG. 12b) of the left and right signals at collection of sounds generated by the system of the present embodiment by the dummy head microphone 54 and with a wave B the level and phase of differences with a single sound source being arranged in the left side of the dummy headphone 54. The ordinate in FIG. 12b indicates the decibel ratio between the left and right pp signals.

The ordinate in FIG. 12b is a radian indication f the right pp signal delay.

It is clear that the right pp delay is signal in the negative value region.

As is clear from comparison of the waves A, B in FIGS. 12a and 12b, it is observed that well approximate difference in level and phase of the left and right signals are obtained in the system of the present invention when the sound source is arranged on the left and a sound field same as the one with the sound source on the left (i.e. a sound field broader than the position of the real speaker 20) can be regenerated. When an audience hears sounds regenerated by the system of the present embodiment, he or she perceives a sound field with the sound source being on the left side, It was confirmed that the sound image orientational direction was effectively enlarged.

In the case of the above-described embodiment, a sound field adjustment filter 38 was provided having an impulse response hc in the form of an addition of impulse responses hcᵢ over bands. The present invention is not limited to this embodiment. Impulse filters having impulse responses hcᵢ may be provided for respective bands and addition of the signals pas the filters may be subtracted from another signal.

### BRIEF DESCRIPTION OF THE DRAWINGS

FIG. 1 is a system diagram of one embodiment of the acoustic regeneration in accordance with the present invention,

FIG. 2 is a cross-sectional view of a speaker possessed by the acoustic regeneration system of the present invention,

FIG. 3 is a flow chart of a process for designing the sound field adjustment filter possessed by the acoustic regeneration system in accordance with the present invention,

FIG. 4 depicts the step to obtain the first test signal left and right the impulse responses of respective bps in designing of the sound field filter,

FIG. 5 depicts the step to obtain the second test signal left and the first test signal,

FIG. 6 depicts the step to measure the measurement signal SLᵢ, Srᵢ,

FIG. 7 depicts the step to measure the reference signals SL* and SR*,

FIG. 8 depicts the step for band integration,

FIG. 9 depicts the phase delay time,

FIG. 10 depicts the step to obtain the impulse response hcᵢ from bps filter impulse response δᵢ for respective bands

FIG. 11 depicts the step to obtain the impulse response hc as the sound field adjustment characteristics from the impulse responses hcᵢ,

FIG. 12 depicts the frequency characteristics of a regenerated sound from the sonic regeneration system in accordance with the current embodiment and

FIG. 13 depicts S the frequency characteristics of the sound pressure at a q having common vibration boards for left and right channels.

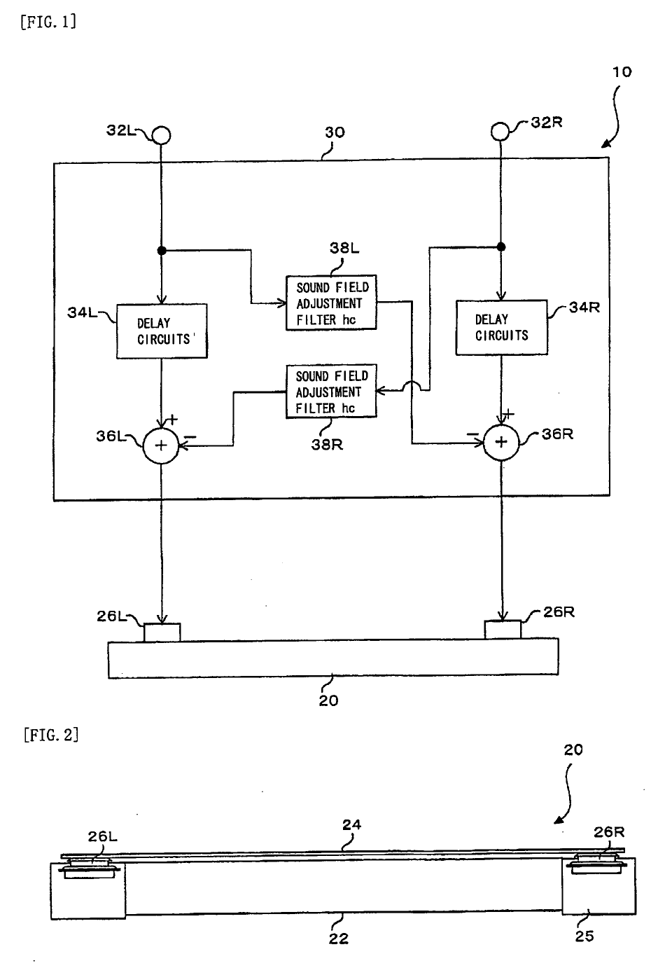

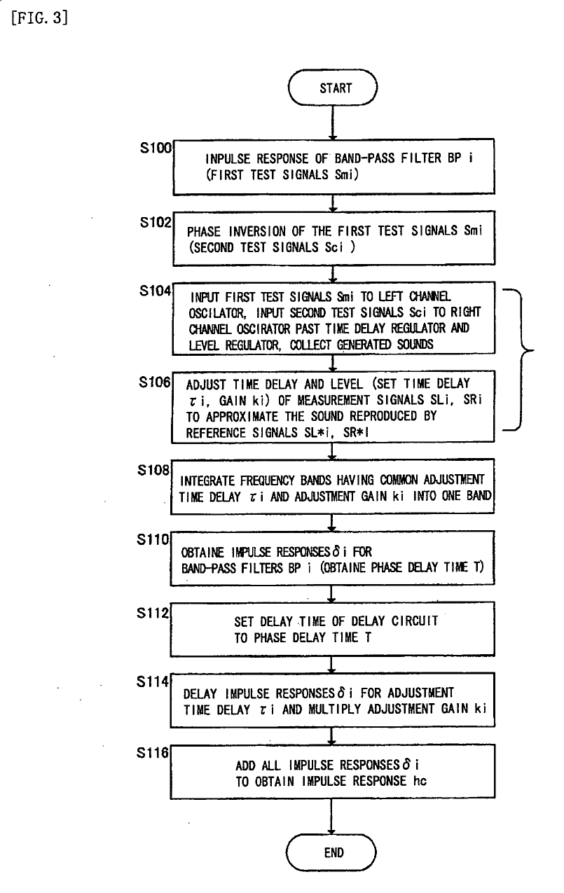

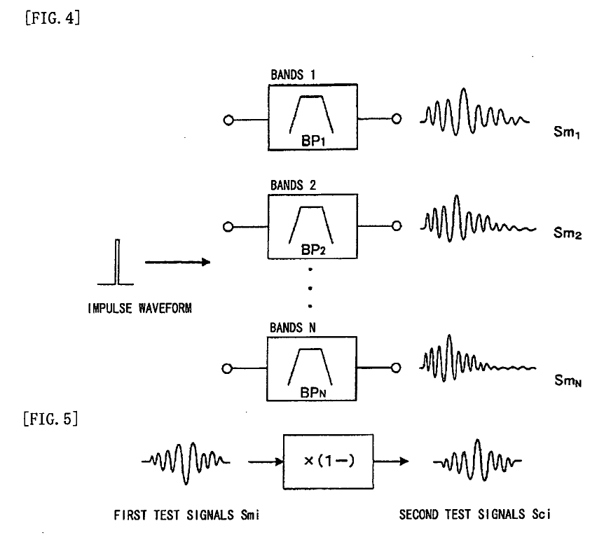

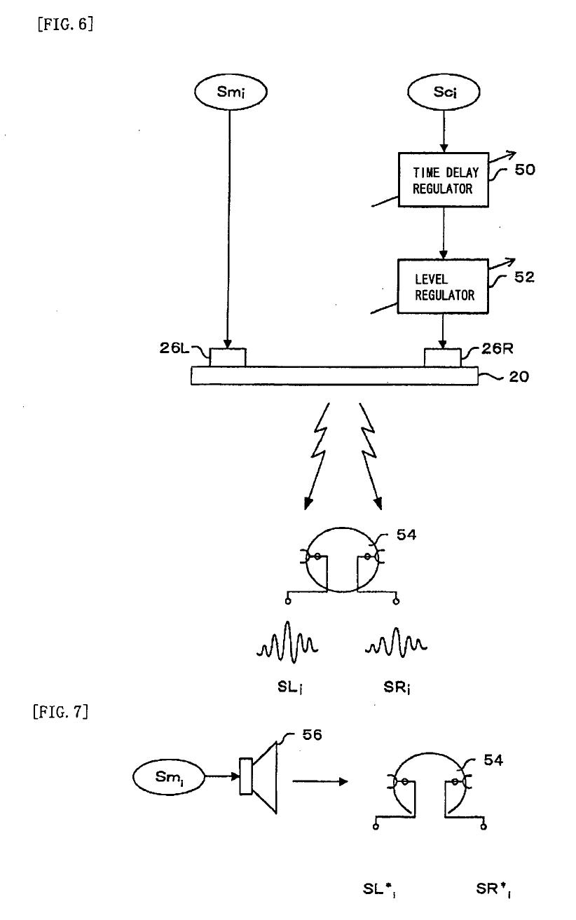

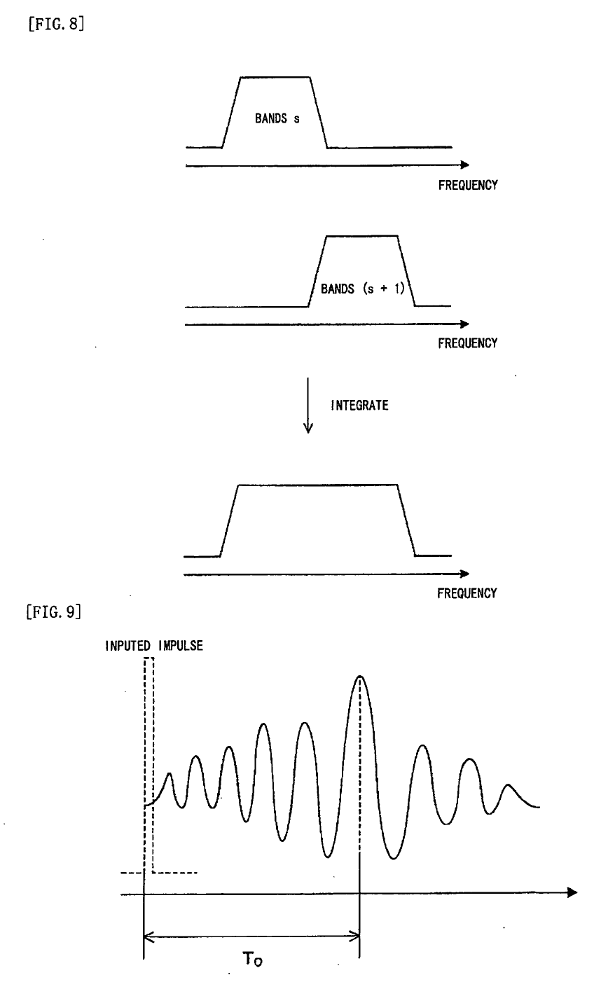

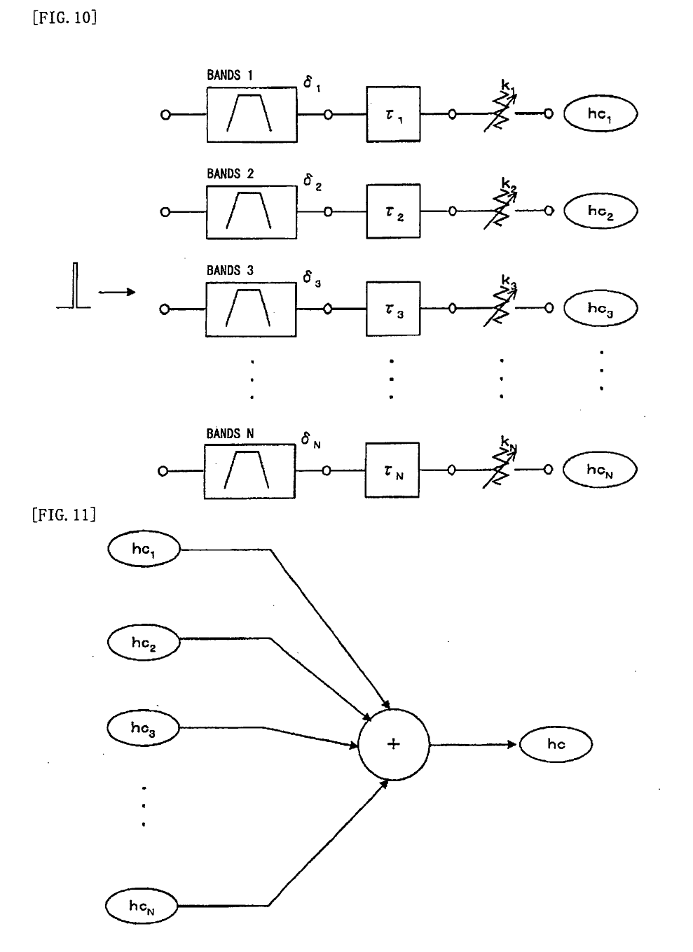

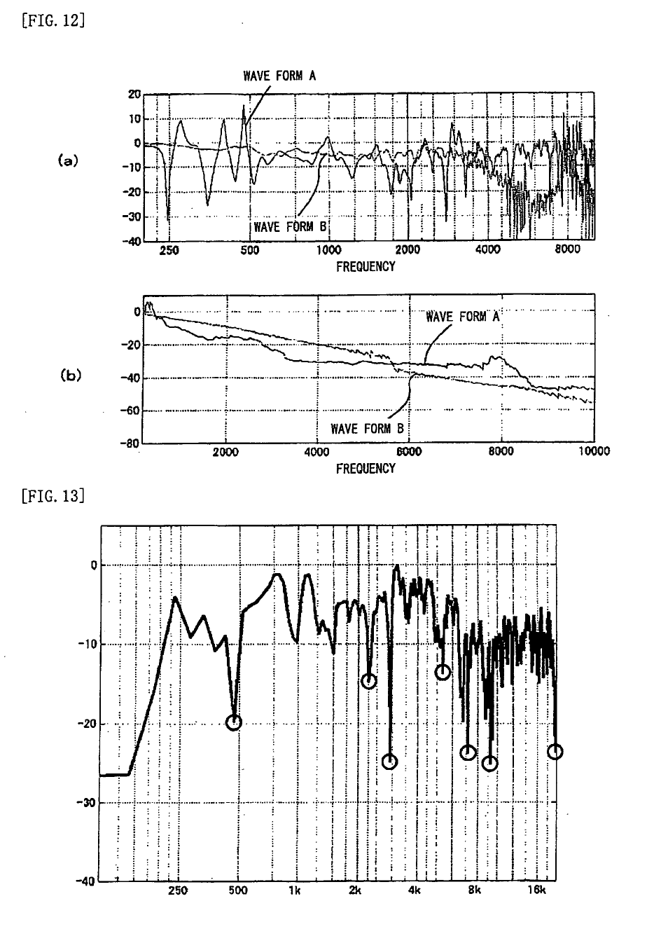

### SYMBOLS

BPᵢ filter
Smᵢ the first test signal
Scᵢ the second test signal
SLᵢ, Srᵢ measurement signal
SL*,SR* reference signal
τᵢ adjustment time delay
kᵢ adjustment gain
δᵢ, hcᵢ, hc impulse response
10 acoustic regeneration system
20 speaker
22 liquid crystal unit
24 transparent panel
26 (26L, 26R) oscillator
32 (32L, 32R) input terminal
30 acoustic signal processing apparatus
36 (36L,36R) operational output
34 (345L, 34R) delay circuit
38 (38L, 38R) sound field adjustment filter

1. An acoustic signal processing apparatus in which sounds are regenerated by a speaker provided with common vibration boards arranged in left and right channels and oscillators corresponding to the left and right channels for vibrating said vibration boards comprising a pair of input terminals receptive of left and right channel signals,
a pair of delay circuits for passage of said input left and right channel signals with prescribed time delays, a pair of operational outputs for processing said left and right channel signals past the delay circuits and outputting to said oscillators, a pair of sound field adjustment filters for passage of said input left and right channel signals to said operational outputs of other channels characterized in that said sound field adjustment filter comprises a plurality of band-pass filters covering in cooperation desired frequency bands so as to have same delay time, time delay fixing means for attaching prescribed additional time delays to respective band-pass filters and gain fixing means for attaching prescribed additional gains, that the delay time of said delay circuit is fixed so as to correspond to the delay time of said plurality of band-pass filters, that said operational output is fixed so as to subtract signals of other channels input past said sound field adjustment filter from signals of left and right channels past said delay circuit and output the result to the oscillators as corresponding signals of said speaker and additional time delay of said time delay fixing means and additional gain of said gain fixing means are fixed so that outputs obtained when impulses are input to a plurality of test band-pass filters equivalent to said plurality of band-pass filters are taken as first test signals Smi, phases of said first test signals Smi are inverted to obtain second test signals Sci, said first test signals Smᵢ is input to one channel of said speaker, said second test signals Scᵢ are input to other channel of said speaker past time delay regulator and level regulator and sounds generated by said speaker are collected by a stereo microphone to obtain measurement signals SLᵢ and SRᵢ,
a sound source generative of sounds corresponding to said first test signals Smi or said second test signals Sci is arranged on the left or right side of said speaker to obtain reference signals SL* and SR*, time delay and level are adjusted by said time delay regulator and level regulator so that said measurement signals SLi and Sri should approximate said reference signals SL*I and SR*I, said adjusted time delay is taken as adjusted time delays τi gain of said adjusted level to said first test signals Smi is taken as adjustment gain ki and additional time delay of said time delay fixing means of said sound field adjustment filter and additional gain of said gain fixing means are fixed to be said band-pass time delay τi and said band-pass gain ki.

2. Method for designing acoustic signal processing apparatus as claimed in claim 1 comprising a step to fix delay time of said delay circuit so as to correspond to delay dime of as plurality of band-pass filters, a step to obtain first test signals Smi from an output when impulses are input to a plurality of test band-pass filters BPi equivalent to said plurality of band-pass filters in said acoustic processing apparatus, a step to obtain second test signals Sci by inversion of phases of said first test signals, to input said first test signals Smi to on e channel of said speaker, input said second test signals Sci to the other channel of said speaker past time delay regulator and level regulator and to collect sounds generated by said speaker as measurement signs SLi and SRi,
a step to obtain reference signals SL* and SR* from sounds when a sound source generative of sounds corresponding to said first test signals Smi or said second test signals Sci is arranged on the left of right side of said speaker,
a step to adjust time delay and level by said time delay regulator and said level regulator so that said measurement signals SLi and SRi should approximate said reference signals SL*I and SR*i.
a step to obtain said adjusted time delay as adjustment time delay τi
a step to obtain gain of said adjusted level with respect to said first test signals Smi as adjustment gain ki and
a step to fix said additional time delay of said time delay fixing means and additional gain of said gain fixing means as said adjustment time delay τi and said adjustment gain ki.

3. An acoustic signal processing apparatus for regeneration of sounds by a speaker provided with common vibration boards for left and right channels and oscillators for vibrating said vibration boards according to left and right signals comprising a pair of input terminals receptive of left and right signals, a pair of delay circuits for passage of said signals of left and right channels with prescribed time delay, a pair of operational outputs for processing left and right channel signals past said delay circuits for output to said oscillators and a pair of sound field adjustment filters for passage of said input left and right channel signals to said operational output of other channels characterized in that said sound field z filters comprise a plurality of band-pass filters covering in cooperation desired frequency bands and having same delay times, time delay fixing means for attaching prescribed additional time delays to said band-pass filters and gain fixing means for attaching prescribed additional gains, that delay time of said delay circuit is fixed so as to correspond to delay time of said plurality of band-pass filters, that said operational outputs are fixed so as to subtract signals of other channels input past said sound field adjustment filters from left and right channel signals input past said delay circuit and to output the result to said oscillators as signals of channels corresponding to said speaker and that additional time delay of said time delay fixing means and additional gain of said gain fixing means are fixes so that outputs obtained by inputting impulses to a plurality of test band-pass filters. BPi equivalent to said plurality of band-pass filters are output as first test signals Smᵢ, phases of said first test signals are inverted to obtain second test signals Scᵢ, said first test signals Smᵢ are input to one channel of said speaker, said second test signals Scᵢ are input to the other channel of said speaker past time delay regulator and level regulator, sounds generated by said speaker are collected by a stereo microphone to obtain measurement signals SLᵢ and Srᵢ, reference signals SL* and SR* are obtained by folding said first test signals with both ear impulse responses in the form of Fourier reverse transformation of transmission function HRTF from a position on the left or right side of said speaker to the head of an audience for frequency bands corresponding to said frequency bands
time delay and level are adjusted by said time delay regulator and level regulator so that said measurement signals SLi and Sri should approximate said reference signals SL* and SE*, said adjusted time delay is taken as adjustment time delay τi, gain of said adjusted level with respect to said first test signals Smᵢ is taken as adjustment gain ki and said additional time delay of said time delay fixing means of said w adjustment filters and additional gain of said gain fixing means are fixed as said adjustment time delay τi and said adjustment gain ki.

4. Method for designing acoustic signal processing apparatus as claimed in claim 2 comprising a step to fix delay time of said delay circuit so as to correspond to said plurality of band-pass filters, a step to obtain first test signals Smᵢ by inputting impulses to a plurality of test band-pass filters BPi equivalent to said plurality of band-pass filters of said acoustic signal processing apparatus, a step to invert said first test signals to obtain second test signals Scᵢ, a step to input said first test signals Smᵢ to one channel of said speaker, a step to input said second test signals to the other channel of said speaker past time delay regulator and level regulator, a step to collect sounds generated by said speaker by a stereo microphone to obtain measurement signals SLi and SRi a step to obtain reference signals SL*ᵢ and SR*ᵢ by folding said first test signs with both ear impulse responses in the form of Fourier reverse transformation of transmission function from a apposition on the left or right of said speaker to the head of audience for frequency bands corresponding to said frequency bands i, a step to adjust time delay and level by said time delay adjustment regulator and level regulator so that said measurement signals SLi and SRi should approximate said reference signals SL*ᵢ and SR*ᵢ, a step to take said adjusted time delay as adjustment time delay τi, a step to take gain of said adjusted level with respect to said first test signals Smᵢ as adjustment gain ki, and a step to fix additional time delay of said time delay fixing means and additional gain of said gain fixing means as said adjustment time delay τi and said adjustment gain ki.

5. (canceled)

6. (canceled)

7. (canceled)

8. (canceled)

9. (canceled)

10. (canceled)
